(19) United States
(12) Patent Application Publication
(10) Pub. No.: US 2003/0000390 A1
(43) Pub. Date: Jan. 2, 2003

(54) Gas-water separator for improving filtering effectiveness

(76) Inventor: Yew-Luen Yuan, Taipei (TW)

Correspondence Address: BUCKNAM AND ARCHER, 1077 NORTHERN BOULEVARD, ROSLYN, NY, 11576, US

(21) Appl. No.: 09/883,571

(22) Filed: Jun. 18, 2001

(51) Int. Cl. B01D 47/00

(52) U.S. Cl. 96/357; 96/360; 96/361

(57) ABSTRACT

The invention relates to a gas-water separator and particularly to a gas-water separator used in a washer wherein a plurality of inversed hooks are essentially provided on a surface of a baffle plate facing the air flow so that the water containing impurities can be collected on said inversed hooks and fall down to the bottom smoothly when said water containing impurities is entering into said gas-water separator. As a result, the water content carried by the exhaust air can be greatly reduced, even only dry air being exhausted. Thus, the present invention not only can improve the filtering effectiveness but also can be more environment-philic.

### BACKGROUND OF THE INVENTION

The present invention relates to a gas-water separator and particularly to a gas-water separator used in a washer, wherein a plurality of inversed hooks are essentially provided on the surface, which faces wind, of baffle plate so that the water can be collected and the filtering effectiveness is improved thereby.

Firstly, refer to FIG. 1 and FIG. 2, in which a perspective view of a conventional washer and a top view of a conventional gas-water separator are shown respectively. As shown in the figures, the washer mainly includes at least one water sprayer 12, a filter 14 and a gas-water separator 20 comprising a plurality of baffle plates 22. Contaminated air enters washer from the air intake 10 and going through water sprayer 12, then a part of impurities contained in it being combined with water sufficiently. Some part of water containing impurities falls down to the bottom. Also, some part of water containing impurities falls down to the bottom, when the said water containing impurities is passing through baffle plates 22. The rest of the water containing impurities together with air is discharged through discharge opening 16.

In view of the excess speed of contaminated air entering washer (several hundred and even several thousand cubic meter per minute), substantial water containing impurities is discharged outside together with air. Thus, not only can clean air not be acquired, but also the falling around of water content results in environmental problem. Some washer commercially available can improve above-mentioned problems, however, large cross-flow area is still required in view of the constraint of large air flow rate at several hundred cubic meter or above. This results in too big size of washer to find the installation site. In addition, the cost of such a washer will be inevitably very high.

Therefore, it is the object of this invention to design a washer not only with improved filtering effectiveness but also with lesser cross flow area, so as to meet the requirement of customers. Eventually, the inventor of this invention has created a gas-water separator with improved filtering effectiveness based on his abundant experiences in the field of research and development, sales of relevant products and with his professional knowledge on this respect, and after repeated efforts on designing, sample making, testing and improving.

It is the main object of this invention to provide a gas-water separator wherein a plurality of inversed hooks are essentially fixed on the surface of baffle plates facing the air flow, so that the filtering effectiveness of a washer can be improved thereby.

It is another object of this invention to provide the gas-water separator with improved filtering effectiveness, which is not only simple in its structure and low-cost for manufacturing but also applicable everywhere.

### BRIEF DESCRIPTION OF THE DRAWINGS

FIG. 1 is a perspective view of a conventional washer;

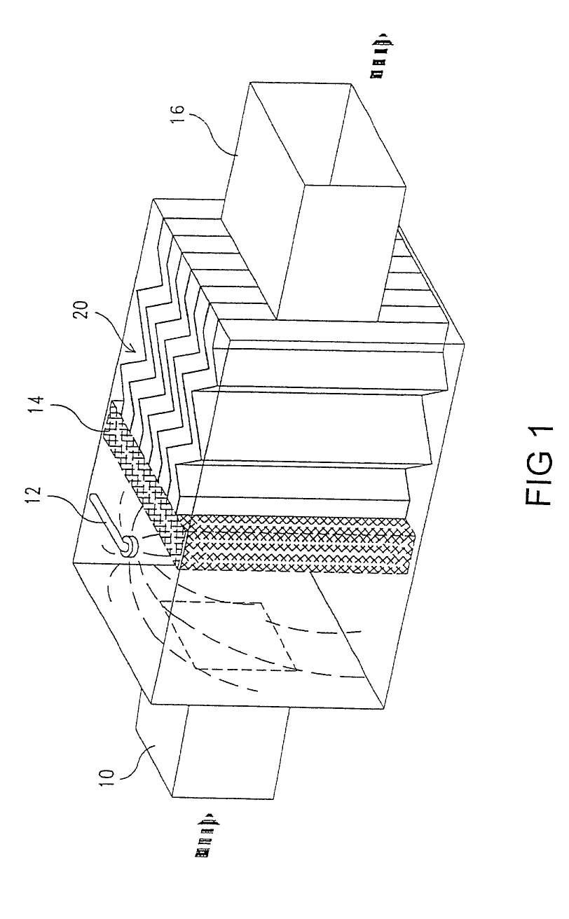

FIG. 2 is a top view of the conventional washer;

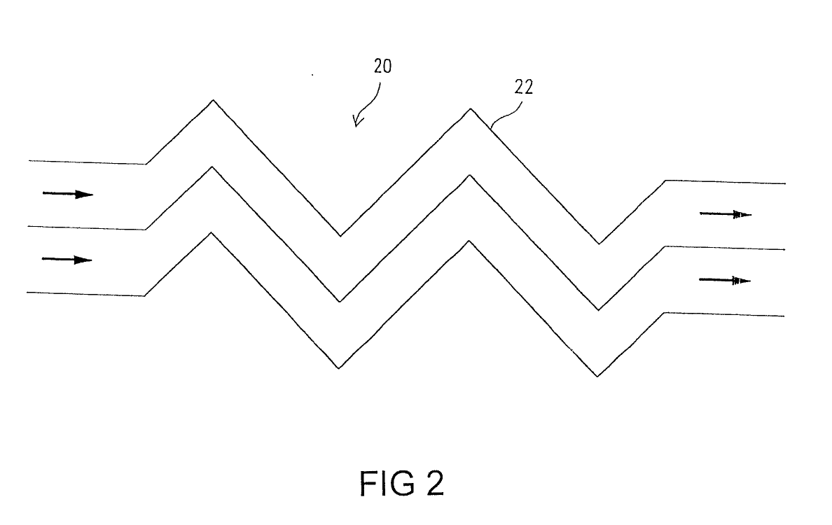

FIG. 3 is a perspective view of a washer of present invention;

FIG. 4 is a top view of the gas-water separator of the present invention.

### DETAILED DESCRIPTIONS OF PREFERRED EMBODIMENT

The characteristics, structure, process and effectiveness achieved of this invention will become more apparent by the detailed description of a preferred embodiment of present invention with reference to its accompanied drawings.

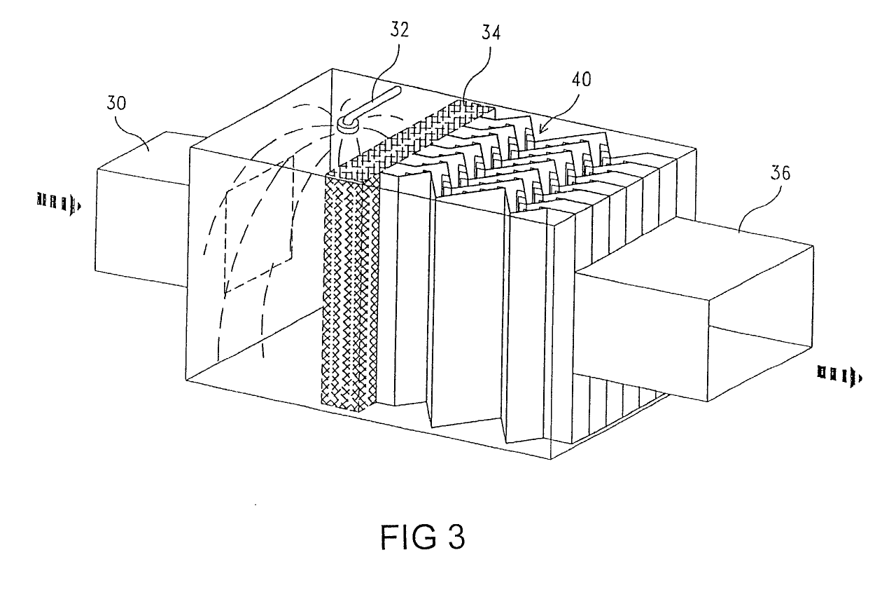

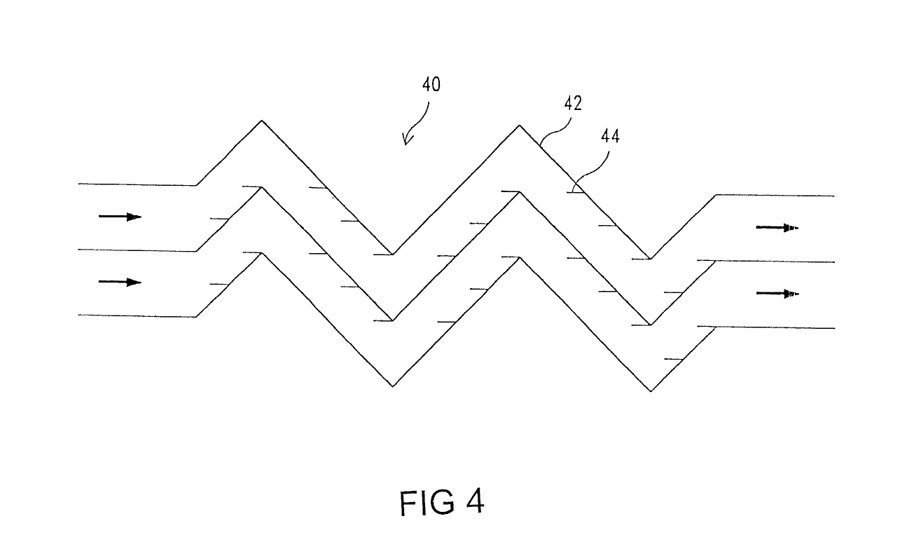

Firstly, refer to FIGS. 3 and 4, in which a perspective view of a washer and a top view of a gas-water separator of the present invention are shown respectively. As shown in the figures, the washer mainly includes at least one sprayer 32, a filter 34 and a gas-water separator 40 comprising a plurality of baffle plates 42 with a plurality of inversed hooks 44 fixed on the surface facing the wind of each baffle plate 42. Contaminated air enters the washer from the air intake 30 and goes through water sprayer 32, then a part of impurities contained in it being combined with sprayed water. In this case, since the falling speed of water is far less then the flowing speed of air intake, most of the water containing impurities is carried forward to the filter 34. Since filter 34 has filtering function and has water content inside it, a part of impurities contained in air will combine with water sufficiently when the air is passing through the filter 34, and some part of water containing impurities is falling down to the bottom because of its much more water content, i.e. much more weight. In view of the provision of a plurality of inversed hooks 44 fixed on the surface facing the wind of baffle plate 42, the water containing impurities will be collected onto said inversed hooks 44 and will fall down to the bottom smoothly by the action of gravitational force.

The water containing impurities may, under excess wind speed condition, fill one of inversed hooks 44 and cross over said inversed hooks 44. However, due to the provision of a plurality of inversed hooks on the each baffle plate 42, the water containing impurities which can cross over one of the baffles 42 cannot cross over all the rest of succeeding baffles 42. Eventually, the water filled in the inversed hooks will fall down to the bottom. As a result, when the air is discharged through the discharge opening 36, the water content carried by the exhaust air can be greatly reduced, even only dry air being exhausted. Thus, the present invention not only can improve the filtering effectiveness but also can be more environment-philic.

This invention provides a plurality of inversed hooks 44 fixed on the baffles 42 of gas-water separator, which results in smaller cross flow area and lesser entire volume of the washer. Accordingly, it is not only simple in its structure and low-cost for manufacturing but also applicable everywhere. In addition, the inversed hooks 44 on the baffles 42 are plate or hook shape.

Summing up the above, this invention relates to the gas-water separator with improved filtering effectiveness, characterized in that a plurality of inversed hooks are fixed on the surface of baffles facing the air flow so that the water containing impurities can be collected onto said inversed hooks. Thereby, the filtering effectiveness can be improved. Therefore, with not only novelty and inventive step but also effectiveness in industrial application, this invention can comply with the element for a patent.

However, it should be noted that all described above is an embodiment of present invention for descriptive and illustrative use only, and should not be considered as a limited case for present invention. Any equivalent variation and modification should be considered within the range of appended claims without departing from the shape, structure, characteristics and spirit of the claims of present invention.

Symbol list of component

| | |
|---|---|
| 10 | air intake |
| 12 | water sprayer |
| 14 | filter |
| 16 | discharge opening |
| 20 | gas-water separator |
| 22 | baffle |
| 30 | air intake |
| 32 | water sprayer |
| 34 | filter |
| 36 | discharge opening |
| 40 | gas-water separator |
| 44 | inversed hook |

What is claimed is:

1. A washer for improving filtering effectiveness essentially comprises a water sprayer and a gas-water separator, characterized in that said gas-water separator consists of a plurality of baffle plates with a plurality of inversed hooks provided on the surface of each baffle facing the air flow; when contaminated air entering washer from an air intake and going through the water sprayer and a filter, impurities contained in the intaken air being combined with water sufficiently; when the water containing impurities being passing through baffle plates, the water containing impurities being collected within said inversed hooks, and falling down to the bottom smoothly by the action of gravitational force so as to improve filtering effectiveness.

2. The washer in accordance with claim 1, wherein the said filter is provided inside said washer such that the impurities contained in air can be combined with water sufficiently.

3. The washer in accordance with claim 1, wherein the said inversed hook of said gas-water separator is of plate shape.

4. The washer in accordance with claim 1, wherein the said inversed hook of said gas-water separator is of hook shape.

5. A gas-water separator for improving filtering effectiveness essentially comprises a plurality of baffle plates, with a plurality of inversed hooks provided on the surface of each baffle facing the air flow.

6. The gas-water separator in accordance with claim 5, wherein the said inversed hook of said gas-water separator is of plate shape.

7. The gas-water separator in accordance with claim 5, wherein the said inversed hook of said gas-water separator is of hook shape.
